(19) United States
(12) Patent Application Publication
(10) Pub. No.: US 2025/0353462 A1
(43) Pub. Date: Nov. 20, 2025

(54) ANTI-THEFT SYSTEM

(71) Applicant: Eclipse Holding, LLC, Eau Claire, WI (US)

(72) Inventors: Troy Meives, Eau Claire, WI (US); Charles Cedarblade, Eau Claire, WI (US)

(21) Appl. No.: 19/180,958

(22) Filed: Apr. 16, 2025

Related U.S. Application Data
(60) Provisional application No. 63/634,643, filed on Apr. 16, 2024.

(51) Int. Cl. B60R 25/08; B60R 25/20; B60R 25/23; B60R 25/40

(52) U.S. Cl. CPC B60R 25/08; B60R 25/2009; B60R 25/23; B60R 25/403

(57) ABSTRACT

The present disclosure relates to an anti-theft system. The anti-theft system may include electrical and mechanical components to prevent, and deter theft. The anti-theft system includes a battery-powered electric system logic board, creating remote-use for the anti-theft system. An arming and disarming feature of the anti-theft system may include using a programmed code on an external keypad.

### TECHNICAL FIELD

The present disclosure generally relates to anti-theft systems. More particularly, embodiments of the present disclosure relate to locks and anti-theft systems for trailers.

### BACKGROUND

Anti-theft systems for trailers are becoming increasingly popular as trailer theft continues to be a major problem. Trailers are an asset and can be easily stolen due to their mobility and lack of security features. Anti-theft systems for trailers come in different forms, ranging from physical locks to GPS tracking systems. These systems aim to prevent theft, deter thieves, and help recover stolen trailers. Trailer or vehicle theft can also increase insurance rates and premiums, and effective security or tracking devices can be used to mitigate those higher prices.

One of the most common anti-theft systems for trailers is a hitch lock. A hitch lock is a device that fits over the hitch coupling and prevents the trailer from being attached to a vehicle. This makes it difficult for thieves to steal the trailer, as they would need to remove the lock first. Another common anti-theft system is a wheel lock, which prevents the trailer from being moved by locking the wheels in place. These locks are relatively inexpensive and easy to install, making them a popular choice for trailer owners. However, these features are not customizable and act as only a preventative measure that does not aid in deterring a thief who is able to break the lock.

GPS tracking systems are also becoming more popular as anti-theft systems for trailers. These systems use GPS technology to track the location of the trailer in real-time. This can help recover stolen trailers quickly, as the owner can track the trailer's movements and notify law enforcement, the owner, insurers, or other relevant parties. GPS tracking systems can also provide geofencing alerts, which notify the owner if the trailer moves outside a designated area. Overall, anti-theft systems for trailers are an important investment for any trailer owner, as they can help prevent theft and provide peace of mind.

Many on-market anti-theft systems for trailers only act as a first defense against theft, meaning they act as a lock or system of preventing the initial theft or attempt. Others act only as a second defense, informing the owner after the fact when the trailer is already gone, potentially empty or damaged. Therefore, there exists a need for an anti-theft system that acts as a lock, but also as a deterrent to add a second defense against theft.

### SUMMARY

The present disclosure relates to an electronic anti-theft system that may be used with trailers attached to vehicles. The anti-theft system is able to detect, deter, and inform the operator of theft attempts. The anti-theft system operates by triggering several indicators to prevent theft and deter individuals who are attempting theft. Using brake control, siren control, and several other features, the anti-theft system may trigger the brakes of a trailer or sound a high decibel alert when the alarm system is tripped, or both.

According to a first aspect of the present disclosure, an anti-theft system may include an indicator panel with several indicators on a first surface of the anti-theft system. Directly below the indicator panel on the first surface of the anti-theft system, there may be a keypad. The keypad is programmable with control codes and a coding system for verifying authorized access and movement. A master code may be used to set user codes and override the anti-theft system. A user code may be used to arm and disarm the anti-theft system. The keypad is in communication with the microcontroller unit, and the microcontroller unit may be configured such that more than one user may have an individual code for locking and unlocking the system.

According to a second aspect of the present disclosure, a method of using an anti-theft system disclosed herein may include attaching the anti-theft system using wires to both a vehicle and to the trailer, fastening a trailer hitch receiver on the hitch of the vehicle, powering the anti-theft system on, programming the keypad with a user code, and arming the anti-theft system. Once armed, the anti-theft system may be able to detect theft attempts, triggering the brake system, and sounding a siren to create a notification of the theft attempt. The anti-theft system may be disarmed by entering either the programmed user code or the master code. In embodiments, the system can be armed and disarmed, and can include an indicator that shows when the anti-theft system is ready for operation or is operating.

According to a third aspect of the present disclosure, an anti-theft system may operate using a system logic board. The system logic board uses a microcontroller unit that is programmed with various circuits to arm, disarm, and operate the anti-theft system disclosed herein. The microcontroller unit may receive inputs/outputs from various components of the anti-theft system, and trigger responses. Examples of inputs/outputs and the triggered response, include an indication that the trailer lock has been tampered with, which would trigger a siren to sound, and the brakes to activate. Additional embodiments of the functions of the microcontroller unit and the system logic board are disclosed herein.

### BRIEF DESCRIPTION OF THE DRAWINGS

Subject matter hereof may be more completely understood in consideration of the following detailed description of various embodiments in connection with the accompanying figures, in which:

FIG. 1 is a perspective view of an embodiment of an anti-theft system.

FIG. 2 is a detailed view of the indicator panel of the anti-theft system of FIG. 1.

FIG. 3 is a detailed view of the keypad of the anti-theft system of FIG. 1.

FIG. 4 is a schematic of an embodiment of the anti-theft system, and the system logic board disclosed herein.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The present disclosure relates to anti-theft systems for use with motor vehicles. The anti-theft systems disclosed herein may aid in preventing theft of trailers that are hitched to a motor vehicle. The anti-theft system connects to both the vehicle and the trailer, providing both physical barriers to theft and multiple cooperative other features to deter and prevent theft such that taking one offline will still trigger the remainder of the system. Several features, including brake control and siren control act as deterrents and preventatives for theft, while other features serve alerting or tracking roles. The anti-theft system includes physical components that are controlled using a system logic board. The system logic board may be programmed with various circuits to complete designated operations in both prevention, alerting, and tracking functions simultaneously so that disabling of a single function does not result in loss of protection for the trailer as a whole.

The anti-theft system may include a battery powered electronic system logic board, allowing it to be used in remote areas where the trailer may be parked. When first engaged, the device measures tilt angles in the x, y, and z axes and stores this data as a reference point. It then continues to measure these angles and compares the new values against the reference points. Should a change occur in any of the three axes that exceeds a specified tolerance value an alarm state is triggered which locks up the brakes and enables the siren. The anti-theft system is housed in a secure enclosure so that it cannot be easily accessed, preventing a potential thief from damaging the device and rendering it inoperable. The enclosure is equipped with a tamper switch that triggers the alarm state, should the enclosure be compromised while in the armed state.

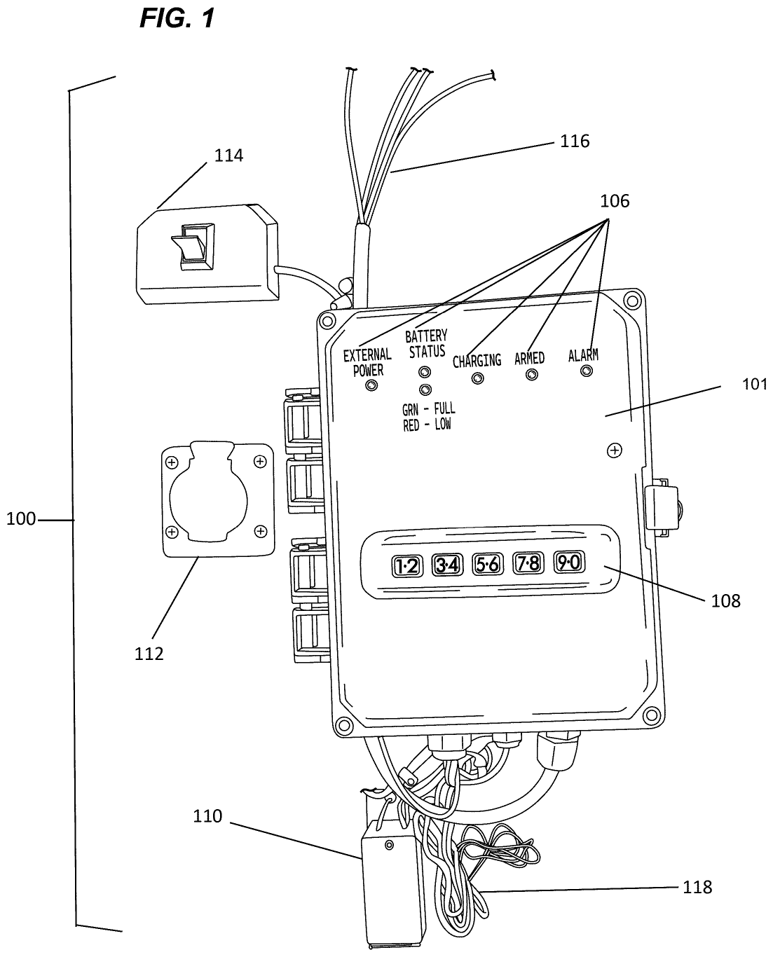

FIG. 1 is a perspective view of an embodiment of an anti-theft system 100 which includes an enclosure 101.

The enclosure 101 provides housing for several components and can be mounted to a vehicle, trailer, or hitch. Enclosure 101 can be made of a material that is suitable for exposure to conditions that are to be expected in those areas, such as mechanical vibration and wind. Furthermore, enclosure 101 can be designed to withstand attempts at tampering. Enclosure 101 can be built of a sturdy material and—as shown in FIG. 1—include a hard shell and sturdy clasps and hinges.

On a surface of the enclosure 101 is a series of indicators 106. The indicators 106 may have LED lights that will illuminate to serve as a notification of one of the systems being used, or that action is required. Directly below the indicators 106 in the embodiment of FIG. 1, there is a keypad 108. The keypad 108 may be used to arm, disarm, and control the anti-theft system 100. The keypad 108 includes a sequence of numbers.

As shown in FIG. 1, the numbers on the keypad 108 are in the order of 1, 2, 3, 4, 5, 6, 7, 8, 9, 0, with two numbers on each of the keys of the keypad 108. In alternative embodiments, keypad 108 could be replaced with any of a variety of alternative password entry alternatives. For example, keypad 108 could be replaced by a different type of keypad, or with a mechanically keyed lock feature. In some versions keypad 108 could use biometric information such as a fingerprint or a retinal scan to unlock. In embodiments there could be an electronic connection, either wired or wireless, that is used to unlock the anti-theft system 100, such as a Bluetooth connection to a user's cellphone that has a password or unlock programming therein, or an RFID reader that connects to a fob or similar device for locking or unlocking the anti-theft system 100. That is, keypad 108 is just an example of a feature for a user to engage with the anti-theft system 100.

The anti-theft system 100 may also include a trailer hitch receiver 110, which allows the anti-theft system 100 to be securely attached to a trailer or a vehicle. Trailer hitch receiver 110 is just one of a variety of features that could be used to affix anti-theft systems (e.g., 100) to other components. For example, in a permanent installation, anti-theft system 100 could be integrated into the inside of the trailer hitch itself, with the user engagement feature(s) (e.g., keypad 108) accessible through a sidewall or wirelessly at a distance. In other embodiments, trailer hitch receiver 110 could be replaced by a welded connection to the exterior of the trailer hitch. In still further embodiments, the anti-theft system 100 could be connected to any other feature, such as the outside wall of a trailer itself. Again, the anti-theft system 100 could be attached to the outside of the trailer or built into the trailer. The reason that a trailer hitch receiver 110 is used in the embodiment shown in FIG. 1 is that trailer hitches are found in only a certain number of sizes, shapes, and configurations. Therefore one trailer hitch receiver 110 can be used on any of a number of trailer hitches and will be interoperable. That is, the trailer hitch receiver 110 permits a single anti-theft system 100 to be used with a large number of trailers, and can be moved from one to another without having to find a different connection mechanism.

The anti-theft system 100 may have a bundle of wires 116 to a vehicle, and a bundle of wires 118 to a trailer. Each bundle of wires (116, 118) connects the main portion of the anti-theft system 100 (that is, the portion housed within the housing 101) to both the vehicle and the trailer simultaneously.

Externally, the anti-theft system 100 may have a power switch 114 to initiate the operation of the anti-theft system 100, and an AC power adapter 112 for external charging of the battery. To power the anti-theft system 100 on, the power switch 114 may be used. Once powered on, the indicator 106 denoting “ARMED” will illuminate an LED light, indicating the anti-theft system 100 is initializing. When the LED light is no longer illuminated, the anti-theft system 100 is ready for operation. It should be understood that the arming process can vary by device, and different combinations of keys, switches, and interactions with the anti-theft system 100 can be used in different embodiments. In most embodiments, once the device is armed it will require a user with a password, key, authenticated wireless connection, or other security credential to disarm the system, and disarming cannot be done merely shutting off the switch 114.

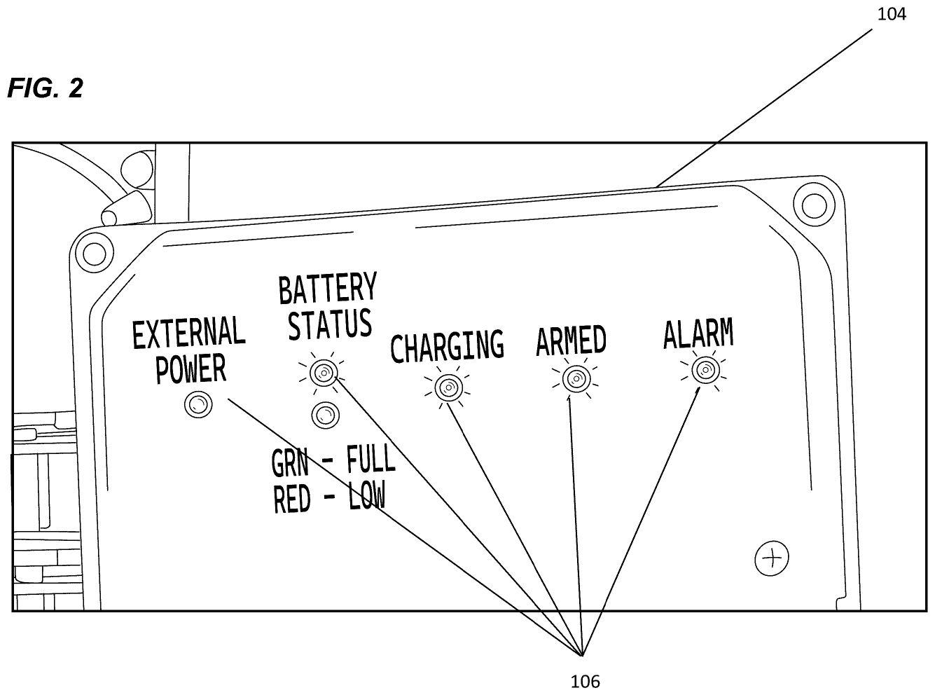

FIG. 2 depicts an embodiment of an indicator panel, with several indicators. The indicator panel 104 may be located on the enclosure 101 of the anti-theft system 100 of FIG. 1. The indicator panel 104 houses the indicators 106 that use LED lights to provide notifications. In one embodiment, the indicators 106 may include an external power, a battery status, a charging, an armed, and an alarm indicator. The LED lights may illuminate in different colors, where a red light may indicate low battery or power, and a green light may indicate full battery or power. The indicators 106 may very in different embodiments, and their order or location on the indicator panel 104 is not crucial or a requirement of the anti-theft system 100.

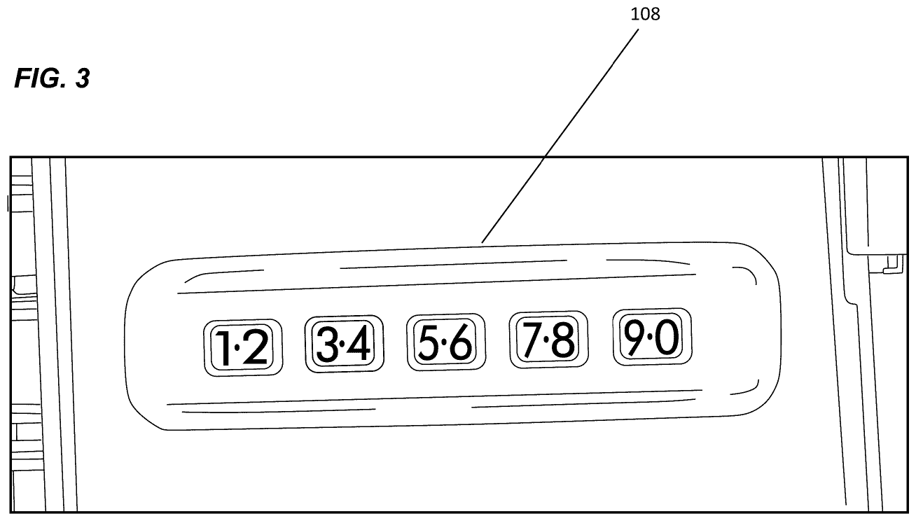

FIG. 3 is an exploded view of a keypad 108 for the anti-theft system 100 of FIG. 1. The keypad 108 is used as a control for the various features of the anti-theft system 100. The keypad 108 may include several keys, with numbers on each of the keys. In one embodiment, there may be five keys, with two numbers on each of the five keys. In the same embodiment, the keys may include the numbers 1, 2, 3, 4, 5, 6, 7, 8, 9, 0, with the numbers paired in twos, i.e., [1 2], [3 4], [5 6], [7 8], [9 0].

The keypad 108 used in the anti-theft system 100 depicted and described herein, is a 5-button device whose buttons illuminate with LED lights when pressed. To conserve battery power the buttons, illuminate after the first button is pressed and will turn off approximately 15 seconds after the last button press is detected. The keypad is used for entering master and user security codes and arming/disarming the system.

In embodiments, the anti-theft system 100 may have two four-digit codes for the keypad 108 that are used for operation: a master code, and a user code. Both codes allow the anti-theft system to be armed and disarmed, and both codes may be used to set new control codes. To set or change the master code, the existing master code must be entered first. To change or set the master code, the [1 2] and the [7 8] keys are pressed at the same time. Then, the new master code may be entered, and an LED light on the keypad 108 will blink once. After the LED light blinks once, the new code is entered a second time. The LED light will blink twice, indicating that the new master code has been accepted and stored.

In embodiments, the user code may be changed by entering either the current user code, or the master code. The [1 2] and the [9 0] keys are pressed at the same time. The LED light will blink once, to indicate that the anti-theft system is ready to accept a new user code. Then, the new user code may be entered. Again, the LED light will blink once, and then the new user code should be entered a second time. The LED light will blink twice indicating that the new user code has been accepted and stored.

The keypad 108 may be used to set the sensitivity of the anti-theft system 100. The anti-theft system may have three levels of sensitivity for both motion and tilt change detection as described in more detail below. To set the sensitivity, the user code or the master code may be entered first. Then, the [3 4] key may be pressed the number of times corresponding to the level of sensitivity desired (i.e., pressed once for the first level of sensitivity, twice for the second level of sensitivity, and three times for the third level of sensitivity). Once the [3 4] key has been pressed for the desired level of sensitivity, the [1 2] key may be pressed to store/save that sensitivity level.

It should be understood that the specific keystrokes, and indeed the input mechanism described above as a keypad 108, can be replaced by other input mechanisms that are sufficiently robust to survive in the context of a trailer environment. Touchscreens, voice control, remote programming and access via an app, networked device, or Bluetooth, Zigbee, or Ecobee connection are all possible alternatives, though some of these (such as a touchscreen) may need to have mechanical protection from water, wind, high and low temperatures, and other mechanical stressors if used on a trailer lock that is exposed to the elements.

Additionally, in embodiments that include remote access and programming via an app, users of the anti-theft system may receive notifications or videos sent to their mobile device. The app may allow for digital or remote keys that are individualized for more than one user. This enables more than one user, with their own individual key to access and control the anti-theft system, from the app on their mobile phone. The app may be configured to allow for arming/disarming the anti-theft system, sending notifications when the system has been tampered with, recording any tampering or activity in the vicinity of the anti-theft system, and allowing a user to view indicator notifications remotely.

In embodiments, the anti-theft system 100 may be located outside of the trailer. In embodiments, the keypad 108 may be outside of the trailer even if the accelerometer 122 is on the inside of the trailer. Because the anti-theft system is keyless and accessible, it provides a good combination of deterrence and convenience. In embodiments, the code used to access the anti-theft system 100 may be updatable over-the-air (in one example, a 2-factor authentication application could be used for continuous updates). Or in another example, updating could be done via a QR code that is read off of a cellular device.

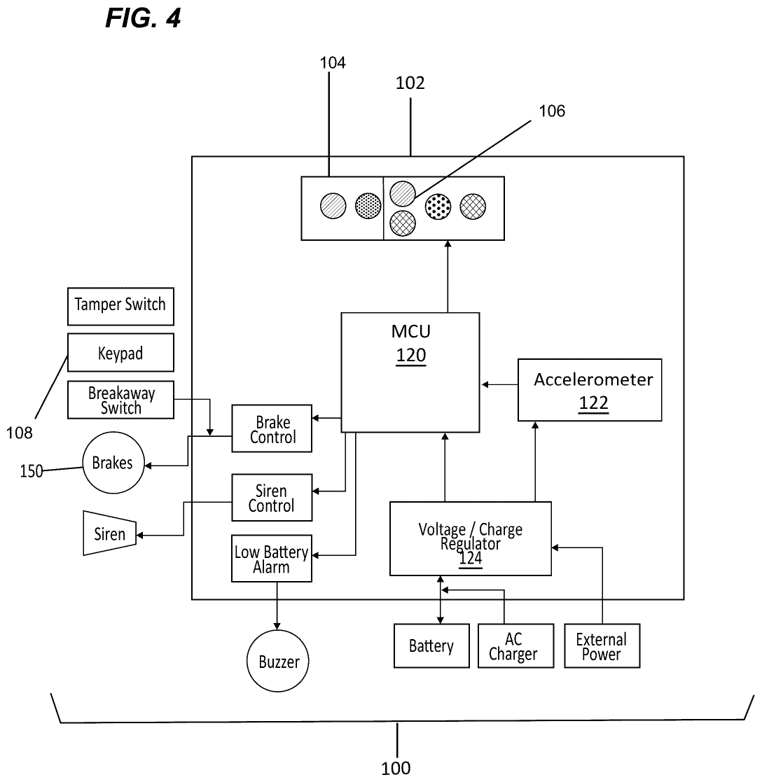

FIG. 4 is a communications schematic of the anti-theft system 100 of FIG. 1. The anti-theft system 100 includes a system logic board 102 that controls the functions of the anti-theft system 100. The system logic board 102 contains a lower power accelerometer integrated circuit which measures tilt angles and motion. A microcontroller unit IC (MCU) 120 monitors the output of the accelerometer as well as performing all the various functions required within the system. The MCU 120 reports information to the indicator panel 104, prompting the system logic board 102 to illuminate the correct LED lights for the indicators 106.

The MCU 120 receives inputs from one or more accelerometers 122, as well as the voltage/charge regulator 124. The voltage/charge regulator 124 receives input from an external power source 126, a battery 130 or battery charger 128, or some combination thereof. The battery 130 may be charged by an AC charger or DC charger 128, or another means of charging such as a wireless charging system. The system logic board 102 also controls the functions of electric brakes 150. In an embodiment, triboelectric generators, piezoelectrics, or other materials and systems that generate power for movement can be used to charge the device and can be used as charger 128. As shown in FIG. 4, charge can also be provided directly to the voltage/charge regulator 124 from charger 128.

The MCU 120 sends outputs to brake control 132, siren control 134, and low battery alarm 136 circuits. The circuits (132, 134, 136) then can trigger several functions or features.

For example, the brake control circuit 132 can prompt the brakes to initiate during a theft attempt, preventing the vehicle and/or trailer from being driven. Brake control circuit 132 can include safety features to deter theft while protecting people and property. For example, brake control circuit 132 can implement a safe stop, with gradually increasing braking using the electric brakes 150. In some embodiments brake control circuit 132 can also detect, either alone or in combination with accelerometers 122 and the MCU 120, when a locked-brake condition has occurred and release some braking pressure.

In embodiments, the accelerometers 122 may be located near the front of a trailer, where near could be about 8-10 feet from the front of the trailer. In another embodiment, the accelerators 122 may be located on the tongue, or on the trailer body. The accelerometers 122 should be located far enough from the pivot point (e.g., axle) to detect lifting and dropping of the front of the trainer where it is hitched to the vehicle, therefore the accelerometers 122 may be suitable in various locations.

Additionally, or alternatively, the siren control circuit 134 sounds a siren, creating an audible deterrent and notification of the attempted theft. Sirens are typically only effective during the beginning of a theft, and to save battery and be effective in some versions the siren control circuit 134 can activate the siren only when the trailer is not moving or when it is moving at a low speed, for example.

In embodiments, when the battery of the system logic board 102 is low—even when a theft attempt has not been detected—the low battery alarm may prompt a buzzer, notifying the user that it is time to charge the anti-theft system 100 or replace the battery.

In addition to the brakes and siren, there can be other features that are electronically or communicatively coupled to the system logic board 102, such as a tamper switch, the keypad 108, and a breakaway switch that may be powered by the anti-theft system but is independent from the anti-theft system. The breakaway switch may allow the trailer safety braking system to be powered from the same battery used for the anti-theft system 100, along with the sharing the same wiring to the brakes themselves. In embodiments, the breakaway switch is not monitored by the anti-theft system 100; the connection point is provided as a convenience to avoid the need for a separate battery for the breakaway switch. If there is failure or general malfunctioning of the battery-powered brake system, the breakaway switch may be activated. In a preferred embodiment, one battery powers both the anti-theft system, and the breakaway switch. In alternative embodiments, the anti-theft system and breakaway switch may each have independent batteries for operation.

The accelerometer is a gravity-controlled device, that senses movement in three directions (x, y, and z) when its position changes relative to the earth's surface. The sensitivity of the device is programmable, making it possible to sense larger changes in position while ignoring minor fluctuations due to wind or ground vibrations. The variability in settings for sensitivity is controlled by the user. The keypad 108 or other user input device may be used to set the sensitivity of the anti-theft system 100. The anti-theft system may have three levels of sensitivity for both motion, and tilt change detection. In one embodiment, there may be three settings of user-selectable sensitivity. In additional embodiments, more than three settings may be programmed.

In the keypad-based example of FIG. 1, to set the sensitivity the user code or the master code may be entered first. Then, the [3 4] key may be pressed the number of times corresponding to the level of sensitivity desired (i.e., pressed once for the first level of sensitivity, twice for the second level of sensitivity, and three times for the third level of sensitivity). Once the [3 4] key has been pressed for the desired level of sensitivity, the [1 2] key may be pressed to store/save that sensitivity level. It should be understood that this is just one example of a way to adjust the sensitivity, and that different programming steps or settings modification schemes could be used in various alternative embodiments.

The accelerometer disclosed herein is used to sense both tilt and acceleration due to motion. This allows the unit to react to up and down movement of the trailer, should the jack be raised or lowered as well as front or back motion, and in scenarios where the trailer is hooked up to a towing vehicle and an attempt is made to move it. This two-pronged approach provides greater security from any attempt at unauthorized transport of the trailer compared to conventional systems, in which a sensor may only detect movement of a wheel, or one or the other of the movement modes described above.

In addition to monitoring the keypad 108 and motion sensor of the accelerometer, the MCU 120 also monitors the voltage level of the device's battery 130. The normal output voltage of a fully charged lead-acid battery may be, for example, 12.6 volts and decrease with decreasing charge. If the voltage level remains above 2.1 volts (the 50% charge level) a green battery status LED will be illuminated on the indicator panel 104. Once the voltage drops below that point, the green status LED will be turned off and the red battery status LED will light on the indicator panel 104, indicating that the battery level is low and should be recharged. Further, an audible chirp or other alarm may also be sounded occasionally, such as every 15 seconds, to alert anyone in the vicinity that the battery charge is running low. The anti-theft system 100 will continue to function at this voltage level, so long as the battery 130 retains adequate charge.

The system logic board 102 may further include a charge regulator 124 with hysteresis characteristics that allows the battery 130 to be recharged when the trailer is connected to a towing vehicle's power system. When external power from a towing vehicle is present and the battery voltage drops below a threshold level of 12.3 volts, the charging circuit or charger 128 will turn on and charge the internal battery. Once the charging circuit is engaged, it will remain on until the internal battery voltage reaches 12.9 volts to ensure that a full charge takes place. After the charge is complete and the charging circuit is disabled, the battery voltage will gradually settle back to 12.6 volts.

A green “External Power” LED is provided which will illuminate the indicator 106 on the indicator panel 104 any time the trailer power connector is attached to a towing vehicle and power from the vehicle is present. This LED will remain illuminated on the indicator panel 104 as long as the connection is in place. For example, if the charge level of the battery is very low, hooking the trailer to a towing vehicle for a very short period may not be sufficient to fully charge the battery, and such indicators can be useful in determining when charging is complete.

When the anti-theft system 100 is armed, the MCU 120 reads the outputs of the accelerometer(s) 122 and stores these values in its internal memory as “zero reference points”. All measurements thereafter are compared to the reference point to determine if a significant enough change has occurred. If such a change is detected while the anti-theft system 100 is armed, an alarm state is enabled, which turns on power to the brakes and enables the siren. Once an alarm state is entered, it remains in effect until the system is disarmed by entering the user code or the master code on the keypad 108. In addition to monitoring the accelerometer(s) 122 and determining an alarm state, the MCU 120 may also monitor the keypad 108, the tamper switch, and controls many of the status LEDs. In embodiments, the external power connection LED and the battery charging LED may not be controlled by the MCU 120 but can instead include their own logic and connections to the battery or a voltage or current meter connected thereto.

The system logic board 102 contains circuitry that can detect when the trailer connector has been plugged into a towing vehicle and contains a charge regulator that allows the battery to be charged from the towing vehicles' electrical system when external power is present. The system logic board 102 also contains inputs for AC powered charger units to be connected that would allow the battery to be charged from an AC power source. This input bypasses the charge regulator circuit, as it is assumed that an external charger contains its own charge regulator.

The system logic board 102 may be designed around the MCU 120, such that the system logic board 102 takes the various inputs from the keypad 108, tamper switch, accelerometer(s) 122, and battery 130 to perform its functions. The MCU 120 may determine when a valid alarm condition occurs, enabling the appropriate outputs to the bakes and siren, and lighting the proper system status LEDs (armed and alarm) on the indicator panel 104. The MCU 120 also monitors the voltage level of the battery 130 and lights the corresponding battery status LEDs on the indicator panel 104 that indicate full charge or low battery condition, as seen on the indicators 106.

The anti-theft system 100 may include a nine position terminals trip, where all connections between the trailer, towing vehicle, breakaway switch, and external charger are made to the system logic board 102. This connector may be color coded making it easy to identify pins in the block and their intended purpose. Table 1 shows the connections to the terminal strip, according to one embodiment.

TABLE 1
External Connections to the System Logic Board

| Terminal | Terminal | | |
|---|---|---|---|
| Block | Block | | |
| Pins | Color | Definition | Notes |
| 1 | Black | Siren (power) | |
| 2 | Black | Siren (common) | |
| 3 | Blue | Breakaway Switch | Power side |
| 4 | Blue | Breakaway Switch | Common side |
| 5 | Green | Output to Trailer | |
| | | Brakes | |
| 6 | Green | Ground | Electrical |
| | | | Common |
| 7 | Green | External Power | From Trailer |
| | | | Connector Plug |
| 8 | Black | External Charger | |
| | | (Positive) | |
| 9 | Black | External Charger | |
| | | (Negative) | |
| Tab | — | Battery (Positive) | |
| Tab | — | Battery (Negative) | |

In additional embodiments, letters, shapes, or numbers may be used to identify pins in the block, and their intended purpose.

The MCU 120 has sufficient input/output (I/O) capacity such that in embodiments, the anti-theft system 100 may include additional functions and capabilities such as GPS location monitoring, wireless connectivity, unique serialized IDs, and storage of other pertinent information.

In assembly, the anti-theft system 100 may have connection wires to connect to a vehicle on one end, and to a trailer on the other end. The wiring to vehicle 116 may include wires that match the wiring to the trailer 118. The wiring to the vehicle 116 and the wiring to the trailer 118 are connected, and operably connect to the anti-theft system 100. On one end of the anti-theft system 100, there may be a trailer hitch receiver 110. Once the anti-theft system 100 is attached to the hitch of a trailer, and the wiring to the vehicle 116, and the wiring to the trailer 118 are connected, the anti-theft system 100 is installed and ready to be used.

In use, the anti-theft system 100 relies primarily on the system logic board 102 to operate. The MCU 120 can be, for example, an Atmel ATMega16 microcontroller unit. The MCU 120 monitors the incoming signals from the accelerometer, the keypad 108 and the tamper switch, as well as from the wiring 116 and the wiring 118. The MCU 120 also monitors the charge of the battery 130, and determines when to trigger an alarm condition, engaging the brakes and/or powering the siren.

To arm the anti-theft system 100, the [9 0] key is pressed twice. The LED light will begin to blink, which indicates that the anti-theft system 100 is calibrating an angle for tilt detection. Once the LED light stops blinking and remains illuminated, the anti-theft system is armed and detecting theft attempts. Conversely, to disarm the anti-theft system 100, the user code or the master code may be entered. Entering the user code or the master code will also clear any alerts on the anti-theft system 100. As above, it should be understood that this is just one way to control the system, and that when programmed differently or when a different input method is used, different controls or commands can lead to the arming and disarming of the system.

In an embodiment, arming or disarming the anti-theft system may be conducted using a wirelessly-connected device.

When an alarm condition is detected (i.e., unauthorized movement of the trailer is attempted), the red “ALARM” LED is illuminated on the indicator panel 104 and the MCU 120 engages a high current output that provides a direct connection between the internal battery and the electric brakes 150 on each wheel drum via the brake control subcircuit 132. In embodiments, at the same time as the brakes are engaged, a siren control circuit 134 that controls an optional siren is turned on. A siren would typically be a high decibel audible alarm and could also include a flashing strobe or other visual indicator to make the trailer that is being stolen highly visible and indicate that a theft attempt is underway. The siren can be a separate device that is connected to the system logic board, allowing it to be located anywhere on the trailer, preferably in a location that would make it difficult to disable. The siren will continue to sound while the unit is armed and in an alarm state. The red “ALARM” LED will also remain on until the unit is disarmed. In embodiments, the siren and brake circuits (134 and 132) can be set up as a “dead man's switch” such that cutting the wires 116 or 118 or tampering with the system 100 results in automatic locking of the brakes and activation of the siren if no proper signal is received from the brake control circuit 132 and the siren control circuit 134.

A tamper switch may be provided inside the housing 101 of the anti-theft system 100 to prevent unauthorized entry into the housing. If the door of the housing 101 is opened while the system is armed an alarm state occurs, providing another level of protection. This may involve adding a door opening sensor (not shown), or similar devices such as a photodiode inside the housing 101 that detects when the housing 101 has been opened based on incoming light.

In addition to battery charging methods described above, the system logic board 102 may also have an input for an external AC power charger that can be used when the unit is parked near an AC power source. The AC power charger may consist of an off-the-shelf charging unit made to accommodate the anti-theft system 100 disclosed herein. Several methods of charging the system logic board 102 and the anti-theft system 100 may be used.

Embodiments of the present disclosure, for example, are described above with reference to block diagrams and/or operational illustrations of methods, systems, and computer program products. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the disclosure in any way. The embodiments, examples, and details provided in this application are considered sufficient to convey possession and enable others to make and use the disclosed embodiments. The disclosure should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the disclosure and the general inventive concept embodied in this application that do not depart from the broader scope.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Any incorporation by reference of documents above is limited such that no subject matter is incorporated that is contrary to the explicit disclosure herein.

Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112 (f) are not to be invoked unless the specific terms “means for” or “step for” are recited in a claim.

What is claimed is:

1. An anti-theft system, the system comprising:
a microcontroller unit;
an accelerometer module configured to detect both dynamic and static acceleration and communicate a signal corresponding to the dynamic and static acceleration to the microcontroller unit;
a brake control circuit communicatively coupled to the microcontroller unit and the accelerometer module and configured to engage a braking system based on the dynamic and static acceleration;
a siren control circuit communicatively coupled to the microcontroller unit and configured to engage a siren based on the dynamic and static acceleration; and
a keypad, wherein the microcontroller unit is programmed with instructions configured that, when implemented, permit entry of a personalized code for locking and unlocking the anti-theft system using the keypad.

2. The anti-theft system of claim 1, wherein the anti-theft system includes a trailer hitch receiver coupled to a housing that contains the microcontroller unit, the accelerometer module, the brake control circuit and the siren control circuit.

3. The anti-theft system of claim 1, wherein the anti-theft system further comprises a tamper switch, and a breakaway switch that can be powered by the anti-theft system but is independent from the anti-theft system.

4. The anti-theft system of claim 3, wherein a system logic board of the anti-theft system can be charged by external power, or by charging an integrated battery using a charger.

5. The anti-theft system of claim 1, the microcontroller unit is configured to allow for multiple users, each having a personalized code to enter on the keypad.

6. The anti-theft system of claim 1, further comprising an indicator panel with a plurality of indicators.

7. A method of using an anti-theft system, the system comprising:
mounting the anti-theft system;
attaching a set of wires on a first end of the anti-theft system to a vehicle and a second set of wires on a second end of the anti-theft system to a trailer;
powering on the anti-theft system;
arming the anti-theft system;
monitoring, at an accelerometer, both static and dynamic acceleration of the anti-theft system against a baseline;
determining, based upon the comparison of the static and dynamic acceleration against the baseline, whether a theft event is occurring; and
activating a braking system and/or a siren system based upon the determination that the theft event is occurring.

8. The method of claim 7, further comprising disarming the anti-theft system by entering a code on a keypad.

9. The method of claim 8, wherein more than one code may be entered on the keypad, corresponding to more than one users of the anti-theft system.

10. The method of claim 7, further comprising arming or disarming the anti-theft system using a wirelessly-connected device.

11. The method of claim 7, wherein arming the anti-theft system enables the braking system, the siren system, and a low battery system.

12. The method of claim 7, further comprising charging an internal battery of the anti-theft system.

13. A system logic board for use with an anti-theft system, the system logic board comprising:
a microcontroller unit, configured to perform a plurality of circuits;
a battery;
charging circuitry coupled to the battery;
an accelerometer configured to sense both tilt and acceleration due to motion;
a brake control circuit, a siren control circuit, and low battery alarm circuit;
an indicator panel with one or more indicators; and
wherein the system logic board is arranged within a housing of the anti-theft system.

14. The system logic board of claim 13, wherein the battery is charged with an AC charger.

15. The system logic board of claim 13, further comprising a memory configured to store a baseline static acceleration, wherein the microcontroller unit is configured to compare the tilt and acceleration sensed by the accelerometer to the baseline static acceleration stored in the memory to determine incidence of a theft event.

16. The system logic board of claim 13, wherein the low battery alarm circuit is configured to activate upon detecting a voltage from a battery that is lower than a predetermined threshold.

17. The system logic board of claim 13, wherein the one or more indicators on the indicator panel can be illuminated with an LED.

18. The system logic board of claim 13, wherein the accelerometer can be set to two or more levels of sensitivity.

19. The system logic board of claim 16, wherein the siren control and the brake control circuits trigger an external siren and external brakes, respectively.

20. The system logic board of claim 13, wherein the indicators on the indicator panel include: external power, battery status, charging, armed, and alarm indicators.
